(19) United States
(12) Patent Application Publication
(10) Pub. No.: US 2019/0340548 A1
(43) Pub. Date: Nov. 7, 2019

(54) SYSTEM FOR BUILDING AND UTILIZING RISK MODELS FOR LONG RANGE RISK

(71) Applicants: International Business Machines Corporation, Armonk, NY (US); Repsol S.A., Madrid (ES)

(72) Inventors: Debarun Bhattacharjya, New York, NY (US); Jeffrey O. Kephart, Cortlandt Manor, NY (US); Jesus M. Rios Aliaga, White Plains, NY (US); Danny Soroker, Larchmont, NY (US); Dharmashankar Subramanian, White Plains, NY (US); Ruben Rodriguez Torrado, Madrid (ES)

(21) Appl. No.: 16/401,146

(22) Filed: May 2, 2019

(30) Foreign Application Priority Data
May 2, 2018 (EP) 18382303.8

(51) Int. Cl. G06Q 10/06; G06N 5/02; G06N 20/00

(52) U.S. Cl. CPC G06Q 10/0635; G06N 20/00; G06N 5/022

(57) ABSTRACT

A system, method and program product for analyzing long term risk. A system is disclosed that includes a risk system for analyzing long-term risks, including: a risk knowledgebase that includes risk information associated with at least one domain; a risk model builder that builds a representation of a risk model based on inputs from a user interface and the risk knowledgebase, wherein the risk model includes risk factor nodes, risk event nodes and impact nodes; and a risk simulation engine that processes the representation and computes predicted outcomes.

### TECHNICAL FIELD

The subject matter of this invention relates to risk models and more particularly to a system and method of building and utilizing a risk model for long range risks.

### BACKGROUND

Many enterprises face long range risks involving years or decades. Unfortunately, it is extremely difficult to evaluate such risks in decision-making and planning. For short-term events involving a time frame of a few days to months, prediction models based on well-known statistical and machine learning models can be built if there is sufficient relevant data. There is often no data however that can be leveraged for modeling risks over a long horizon. Therefore, planners must often rely almost exclusively on the judgments of human beings in the form of assessments.

An example of this occurs in the oil and gas industry. The discovery of new sources of hydrocarbons and development of current sources is of key importance in today's economy. The largest investment and most critical decisions are associated with the early phases of exploration, appraisal and development. Uncertainty about the geology setting of the reservoir, oil price, supply and demand, and complex political scenarios make these investment decisions very challenging. Therefore, a good understanding of these uncertainties could lead to better management of different types of risks, which could be critical to achieving profitability.

A significant amount of effort is expended in the industry on characterizing and modeling the uncertainty about under-the-ground uncertainties (e.g., reservoir properties), referred to as technical risks. However, there has been a more recent and growing recognition that other kinds of risks, such as the weather patterns, environmental regulations, wars and disputes, labor strikes, etc., can have a significant impact on a given enterprise. As such, these risks should be taken into consideration for decisions about acquisition or field development. These uncertainties are referred to as above-the-ground risks or non-technical risks (NTRs). The industry would benefit greatly from having sophisticated tools to help build quantitative models for non-technical risks, so they can be used in conjunction with models for technical risks in a reservoir's life cycle.

### SUMMARY

Aspects of the disclosure provide a system and method of building and utilizing risk models for long range risks (such as NTRs in the oil and gas industry). This disclosed solution provides an analyst or multiple analysts with tools to construct risk models for long-range risks. It involves a risk model representation, a risk model builder and risk model engine/simulator. The risk model representation is a network of risk event nodes, risk factor nodes, and impact nodes plus parameters defining discrete and continuous probability distributions. Risk factors are modeled as discrete nodes, and dynamism in the model is generated through the risk event and impact nodes. This representation is designed to achieve a balance between expressivity and practicality, or in other words, the model can capture a wide range of situations and certain aspects of temporality without requiring an excessive number of parameters. The risk model builder helps construct models consistent with this representation and the risk model engine helps compute over the models by enabling forward simulations that provides samples of the probability distribution of potential impacts.

A first aspect discloses a risk system for analyzing long-term risks, comprising: a risk knowledgebase that includes risk information associated with at least one domain; a risk model builder that builds a representation of a risk model based on inputs from a user interface and the risk knowledgebase, wherein the risk model includes risk factor nodes, risk event nodes and impact nodes; and a risk simulation engine that processes the representation and computes predicted outcomes.

A second aspect discloses a computer program product stored on a computer readable storage medium, which when executed by a computing system, analyzes long-term risks, the program product comprising: program code that accesses risk information associated with at least one domain from a risk knowledgebase; program code that builds a representation of a risk model based on inputs from a user interface and the risk knowledgebase, wherein the risk model includes risk factor nodes, risk event nodes and impact nodes; and program code that processes the representation and computes predicted outcomes.

A third aspect discloses a computerized method for analyzing long-term risks, comprising: providing risk information associated with at least one domain from a risk knowledgebase; building a representation of a risk model based on inputs from a user interface and the risk knowledgebase, wherein the risk model includes risk factor nodes, risk event nodes and impact nodes; and simulating the representation and computing predicted outcomes for a set of parameters.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a computing system having a risk system according to embodiments.

FIG. 2 shows a risk model according to embodiments.

FIG. 3 shows a risk model representation according to embodiments.

FIG. 4 shows a risk model representation according to embodiments.

FIG. 5 shows a flow diagram of a risk model builder process according to embodiments.

FIG. 6 shows a decision tree used by the risk model builder process according to embodiments.

FIG. 7 shows a further decision tree used by the risk model builder process according to embodiments.

FIG. 8 shows a risk model builder interface according to embodiments.

FIG. 9 shows a simulation output of a well in operation over time according to embodiments.

FIG. 10 shows a simulation output of oil production over time according to embodiments.

FIG. 11 shows a composite of multiple simulations depicting a distribution of net present value according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

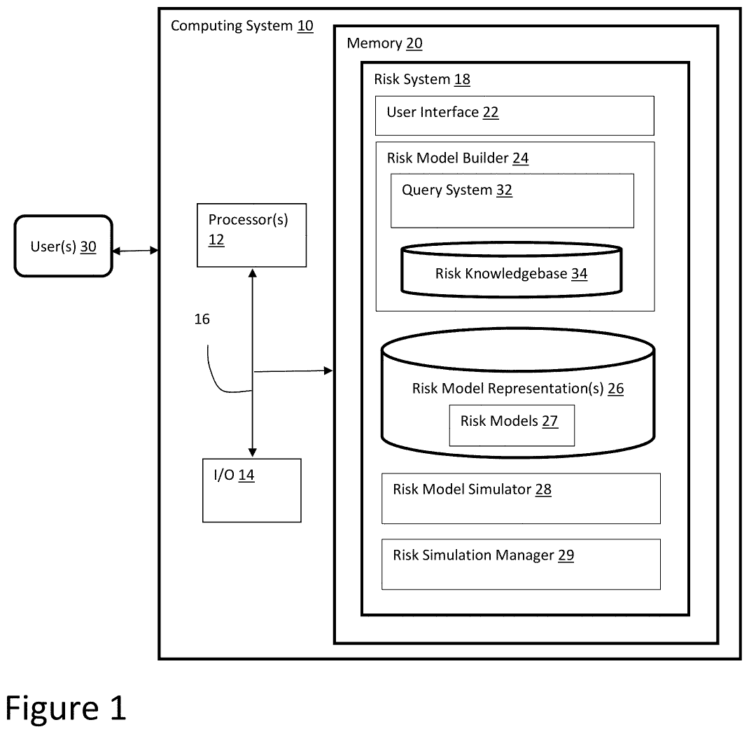

Referring now to the drawings, FIG. 1 depicts a computing system 10 having a risk system 18 for building long range risk model representations 26 and using built risk model representations 26 to simulate risks. Risk system 18 generally includes a user interface 22, a risk model builder 24 that allows a user 30 to build risk model representations 26 (according to a defined risk model 27) and a risk simulation engine 28 that allows a user 30 to perform simulations using a risk model representation 26. Each risk model representation 26 comprises a structured data object, representable in languages such as JSON or XML, which captures the understanding, attitude and beliefs of a user 30 about the likelihood, duration and impact of one or more risk events. Risk model representations 26 may for example be stored in a database.

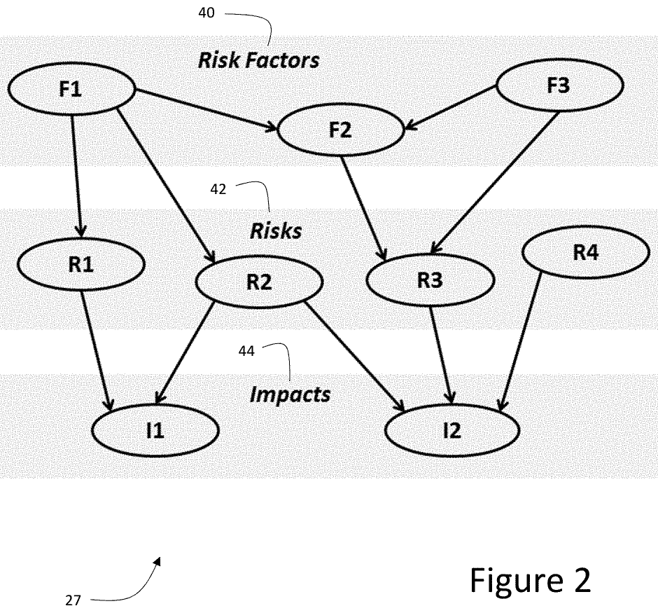

As shown in FIG. 2, the risk model 27 generally comprises a three-tier hierarchy or graph that includes nodes representing risk factors 40, risk events 42 and impacts 44. Each of the risk factors (F1, F2, F3) have discrete states with associated probabilities. For example, a risk factor in oil and gas exploration may include “political unrest” whose state may, e.g., be low or high, and have an associated probability. In general, a risk factor 40 can only have other risk factors 40 as parent nodes. Risk factors 40 can be used to model a variety of influencers that impact risk events 42. For instance, risk factors 40 could involve a temporal aggregation of underlying latent variables (e.g., inequality indices of a country aggregated over time), an unobserved condition or occurrence during a period of interest (e.g., whether an economic indicator passes a threshold), an unobserved condition or occurrence at any particular epoch in time (e.g., election of a particular candidate at the scheduled election), etc.

Risk events or simply “risks” 42 (e.g., R1, R2, R3, R4) are hierarchical children of the risk factors 40 and generally comprise potential events that might occur as a result of the risk factors 40. Risk events 42 may be represented as discrete-state probabilities conditioned on risk factor probabilities and/or continuous distributions that represent the onset of an event (e.g., single-event or recurring), time/frequency of occurrence, and duration. For example, a risk event 42 associate with a “political unrest” risk factor 40 may be “civil war”. Risk events 42 can only have risk factors 40 as parent nodes. Risk events 42 have a defined frequency, either single-event or recurring, depending on how many events could occur in the time period of interest.

Impacts 44 (e.g., I1, I2) are potential consequences of a given risk event 42. Impacts 44 are generally represented as variables with continuous states and therefore continuous probability distributions. Examples of impacts 44 associated with a “civil war” risk include, e.g., partial shutdown of facilities, monetary compensation or fines, loss of life or quality of life, etc. Impacts 44 can only have risk event nodes as parents and must have at least one parent.

FIG. 2 illustrates a graphical risk model 27 with three risk factors 40, four risk events 42 and two impacts 44, however, any number of each may be included in a given risk model representation 26. A risk factor 40 could potentially have multiple parents and could impact multiple risk events 42. For example, F2 has F1 and F3 as parents and F1 affects R1 and R2. A user (e.g., an analyst) could choose to assess risk events 42 without conditioning on risk factors 40 (e.g., R4 has no parent). A risk event 42 such as R2 could have multiple impacts 44, in this case both I1 and I2. Note that graphical models of this form are effectively three-layer models as each of the three types of node has its position in the hierarchy. This does not however put restrictions on the length of a directed path because risk factors could have any number of (risk factor) parents.

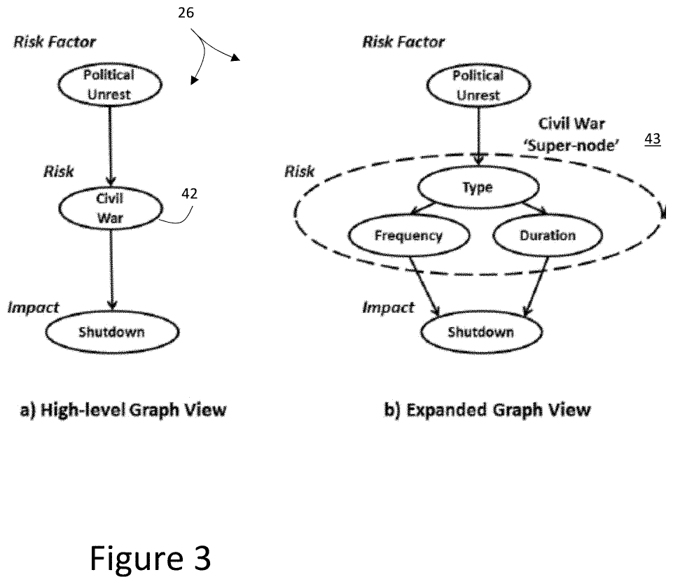

FIG. 3, on the left, depicts an example of a risk model representation 26 (FIG. 1) for risk factor “political unrest” leading to “civil war,” with impact involving a “shutdown” of operations. This example illustrates how a user such as a company analyst might use the graphical model representation to approximately capture risks associated with a production facility over a seven-year period. The high-level model on the left indicates that the analyst has determined that civil war is the most important risk in this region. The analyst may believe that she can assess the risk better by conditioning on political unrest, defined by categories based on a temporally aggregated stability index. Furthermore, the analyst may consider potential shutdown of the facilities to be the major impact to the company.

Each risk event 42 may be further represented as a super-node 43 in the risk model representation, which effectively represents vector-valued variables that are associated with properties of node, including, e.g., a type, frequency and duration. The network representation on the right side of FIG. 3 expands the risk event node into a super-node. The risk super-node is associated with a type (i.e., what kind of civil war), as well as a frequency (how often will it occur) and duration (how long will it last) of the risk event 42. Type is a discrete node; the probabilities of its states are conditioned on the states of its parent risk factor nodes. Note that a state such as “none” can be used to model the case of no risk events. Single-event risks are associated with onset, the time at which the risk might occur, and the duration of the event. Recurring risks are associated with frequency (how often the event occurs), and the duration of each event. A risk event node's onset, frequency and duration may be conditioned on the type, and moreover they may be represented as continuous distributions.

When building a risk model representation 26, the analyst must define a discrete set of states for each risk factor node and assess a marginal probability for each state. In this case, the analyst might define two states for political unrest: ‘low’ and ‘high’, with probabilities 0.75 and 0.25 respectively. The analyst must also define a discrete set of states for each risk event node, and assess the appropriate conditional probabilities. In this case, the analyst might define states of “type” of civil war as “major” and “minor,” and assess the conditional probabilities for war to be “major” as 0.8 if political unrest is “high” and 0.1 if political unrest is “low” (from which it can be derived that the conditional probabilities for war to be “minor” are 0.2 if political unrest is “high” and 0.9 if political unrest is “low”). The analyst must also provide characterizations of the “frequency” and “duration” of the risk events, conditioned upon the type. For example, in this case, the analyst might assess the frequency of events to be Poisson distributed with rate 0:01 per year if the type is “minor” and 0:1 per year if the type is “major.” Furthermore, the analyst could assume that whenever a risk event 42 occurs, the duration of the event (the time period during which the risk event is active). For example, the risk event may be assumed to be uniformly distributed from 1 to 3 years regardless of whether the type is major or minor. The analyst must also assess the impact of risk events over their duration. For example, in this case the analyst may determine that facilities are completely shut down when the risk event is active and 100% operational otherwise. Alternatively, the analyst might posit that over the duration of a war the facility will be between 0% and 50% operational, with the degree of closure generated according to a uniform distribution.

As an example, the following is a JSON representation of a risk model representation 26 pertaining to nationalization. The main features include:
metadata section containing labels, authorship information and timestamps
timeStart and timeEnd timestamps indicating the period of time covered by the risk model
a list of risk factor, risk event and impact nodes, each of which contain metadata describing the name, id and type of node
for each risk factor node
   a list of state labels
   a list of ids of parent nodes (to handle the case where there are multiple levels of risk factor)
   conditional probabilities (conditioned on the state of the indicated parent nodes), or probabilities if there are no parent nodes
for each risk event node
   a riskType indicator to signify whether the event may potentially occur once (“oneShot”) or multiple times
   a severity section containing a list of state labels, parent ids, and conditional probabilities (just as described above for risk factor nodes)
   an onset section describing a discrete or continuous distribution governing onset of the risk event, containing a list of state labels, parent ids, and the distribution
   a duration section describing the duration of the risk event, containing a list of state labels, parent ids, and the distribution
for each impact node
   an impactType parameter providing a label for the type of impact
   an impactDurationType parameter indicating when the impact occurs relative to the onset and duration provided by the risk event node (e.g. “Start”, “End”, or other designation indicating whether the impact occurs at one particular moment or is spread over the duration)
   a randomVariableType parameter indicating whether the impact is described by a discrete or a continuous distribution
   a conditional probability section providing details of the distribution conditioned on states of the indicated parent nodes (typically the state of the parent risk event node)

```
{
“metadata”: {
    “label”: “JeffsExpropriationRiskModel2”,
    “id”: “jerm004”,
    “creator”: {
        “name”: “Jeff Kephart”, “email”:
        “kephart@us.ibm.com”
    },
    “timeCreated”: “2016-01-15”,
    “timeModified”: “2016-01-22”
},
“timeStart”: “2018-01-01”,
“timeEnd”: “2038-01-01”,
“nodes”: [
          {
        “name”: “Resource Nationalism Sentiment”,
        “id”: “rns”,
        “nodeType”: “riskFactor”,
        “randomVariableType”: “discrete”,
        “states”: [“low”, “high”], “parentIds”:
        null,
        “cpd”: [
                  {
                “low”: 0.3,
                “high”: 0.7
            }
        ]
    },
    {
        “name”: “Government Profitability View”, “id”:
        “gpv”,
        “nodeType”: “riskFactor”,
        “randomVariableType”: “discrete”,
        “states”: [“low”, “medium”, “high”],
        “cpd”: [
            {
                “low”: 0.6,
                “medium”: 0.3,
                “high”: 0.1
            }
        ]
    },
    {
                “Expropriation”,
“id”: “exprop”,
“nodeType”: “risk”, “riskType”:
“oneShot”, “severity”: {
      “states”: [“yes”, “no”],
      “randomVariableType”: “discrete”,
      “parentIds”: [“rns”, “gpv”], “cpd”: [
          {
              “parentStates”: { “rns”:
                  “low”,
                          “gpv”: “low”
                        },
                        “yes”: 0.01,
                        “no”: 0.99
          },
          {
              “parentStates”: { “rns”:
                  “low”,
                  “gpv”: “medium”
                        },
                        “yes”: 0.05,
                        “no”: 0.95
          },
          {
              “parentStates”: { “rns”:
                  “low”,
                          “gpv”: “high”
                        },
                        “yes”: 0.20,
                        “no”: 0.80
          },
          {
              “parentStates”: { “rns”:
                  “high”,
                          “gpv”: “low”
                        },
                        “yes”: 0.15,
                        “no”: 0.85
          },
          {
              “parentStates”: { “rns”:
                  “high”,
                  “gpv”: “medium”
                        },
                        “yes”: 0.25,
                        “no”: 0.75
          },
          {
              “parentStates”: { “rns”:
                  “high”,
                          “gpv”: “high”
                        },
                        “yes”: 0.45,
                        “no”: 0.55
              }
          ]
      },
      “onset”: {
          “randomVariableType”: “continuous”,
          “parentIds”: [“exprop”],
          “units”: “year”,
          “states”: [“onset”], “cpd”: [
              {
                  “parentStates”: { “exprop”: “no”
                        },
                        “onset”:null
              },
              {
                  “parentStates”: { “exprop”: “yes”
                        },
                        “onset”: 3.0
              }
          ]
      },
      “duration”: {
          “randomVariableType”: “continuous”,
          “parentIds”: [“exprop”],
          “states”: [“duration”],
          “units”: “month”, “cpd”: [
              {
                  “parentStates”: { “exprop”: “no”
                        },
                        “duration”: 0.0
              },
              {
                  “parentStates”: { “exprop”: “yes”
                        },
                  “duration”: “infinity”
              }
          ]
      }
    },
    {
          “name”: “ExtraCAPEXforExpropriation”, “id”:
          “capex4exprop”,
          “nodeType”: “impact”, “states”:
          [“monetaryLoss”],
          “randomVariableType”: “continuous”,
          “parentIds”: [“exprop”], “impactType”:
          “monetaryGain”, “impactDurationType”:
          “start”,
          “units”: “$.10+6.year−1”, “cpd”:
          [
              {
                  “parentStates”: {
                        “exprop”: “no”
                  },
                  “monetaryLoss”: 0.0
              },
              {
                  “parentStates”: { “exprop”:
                        “yes”
                  },
                  “monetaryLoss”: { “distributionType”:
                        “gaussian”, “mean”: −10.0,
                        “standardDeviation”: 5.0
                  }
              }
          ]
    },
    {
          “name”: “Compensation”, “id”:
          “comp4exprop”, “nodeType”:
          “impact”,
          “randomVariableType”: “continuous”, “states”:
          [“monetaryGain”],
          “parentIds”: [“exprop”], “impactType”:
          “monetaryGain”, “impactDurationType”:
          “start”, “units”: “$.10+6”,
          “cpd”: [
                      {
                  “parentStates”: {
                        “exprop”: “no”
                  },
                  “monetaryGain”: 0.0
              },
                {
                      “parentStates”: { “exprop”:
                          “yes”
                      },
                      “monetaryGain”: {
                          “distributionType”:
                          “triangular”, “low”: 5.0,
                                  “peak”: 15.0,
                                  “high”: 25.0
                      }
                }
            ]
      },
      {
            “name”: “Well Fraction”, “id”:
            “wf4exprop”, “nodeType”:
            “impact”,
      “randomVariableType”: “continuous”, “states”:
      [“wellFractionMultiplier”], “parentIds”:
      [“exprop”],
      “impactType”: “wellFractionMultiplier”,
      “impactDurationType”: “extend”,
      “units”: “10-2”, “cpd”:
      [
          {
              “parentStates”: {
                    “exprop”: “no”
              },
              “wellFractionMultiplier”: 100.0
          },
          {
              “parentStates”: {
                    “exprop”: “yes”
              },
              “wellFractionMultiplier”: 0.0
          }
    ]
    }
          ]
    }
```

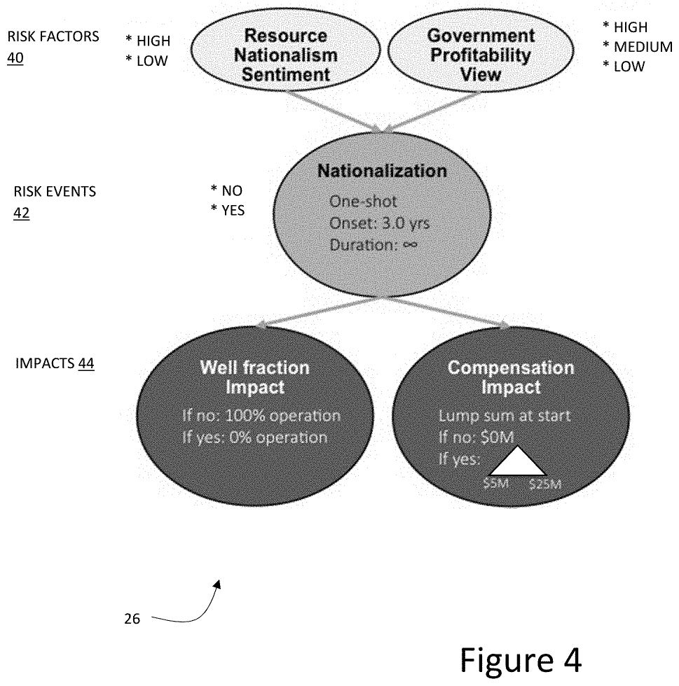

FIG. 4 provides a pictorial representation of a completed (or partially completed) risk model representation 26 describing nationalization risk. In this particular example, there are two risk factors 40: resource nationalism sentiment (which can be in either a Low or a High state) and government profitability view (which can be in a Low, Medium, or High state). The state of these two risk factors influences whether or not the risk event 42 nationalization occurs according to defined conditional probabilities. If nationalization ends up in the state Yes, then the nationalization is assumed to be one-shot (i.e., it can happen at most once), to occur 3.0 years after the beginning of the time epoch under consideration, and last indefinitely. If nationalization ends up in the state No, then nothing happens.

If and when nationalization occurs, two impacts 44 ensue from that event. First, the fraction of wells that remain in operation is 100% if nationalization does not occur, and 0% if it does. Second, there will be monetary compensation from the government of an amount given by a triangular probability distribution running from a minimum of $5M to a maximum of $25M with a peak at $15M.

As noted in FIG. 1, the risk model builder (RMB) 24 is provided to assist a user 30 building a risk model representation 26 for a given domain, which includes a probabilistic model of the likelihood, duration and impact of a risk event that may occur in the future. Although the examples described herein are generally directed to risks associated with oil and gas exploration, it is understood that the described systems and processes may be applied to any domain that is subject to long-term risk, e.g., making a technology infrastructure investment in a developing country, building a power plant in a politically unstable region, etc.

The JSON example provided above is an example of output that might be generated by RMB 24. RMB 24 utilizes a user interface 22 and query system 32 that elicits from the user 30 various details needed to build a risk model representation 26. RMB 24 creates a bridge between concepts and beliefs of the user 30 and those required by the risk model representation 26. To achieve this, RMB 24 presents meaningful questions to the user via the query system 30 to extract details needed for a precise representation of the risk model 27.

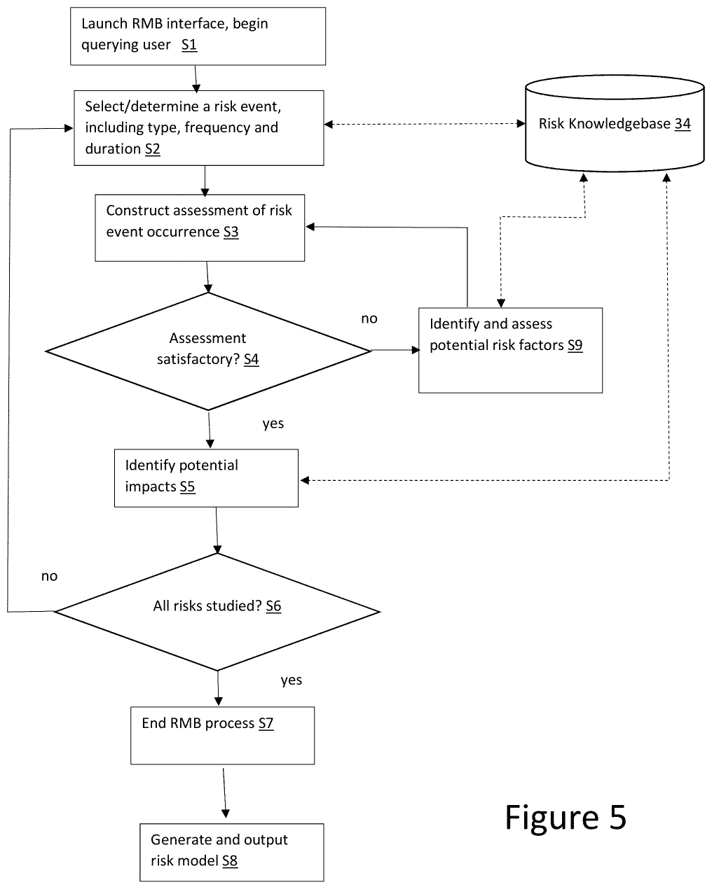

An example of the risk model building process is illustrated in the flow diagram of FIG. 5 (with reference to FIG. 1). At S1, an RMB interface is launched and begins querying the user for risk information for a particular domain. The RMB 24 has a GUI that guides the user 30 through a sequence of questions about the risk for which the model is being utilized. At S2, a first risk event is selected/determined, e.g., based on a user selection, querying, etc. A risk knowledgebase 34 may be utilized to facilitate the process by providing stored risk information, including information arranged in a taxonomy, such as the Cambridge Risk Taxonomy (see, http://cambridgeriskframework.com/taxonomy). Other risk data may comprise unstructured information that the risk system 18 and/or user 30 can access. Risk events may for example include, nationalization, war, extreme weather, etc. As noted above, details about the risk event, such as type, frequency and duration may also be ascertained at this point.

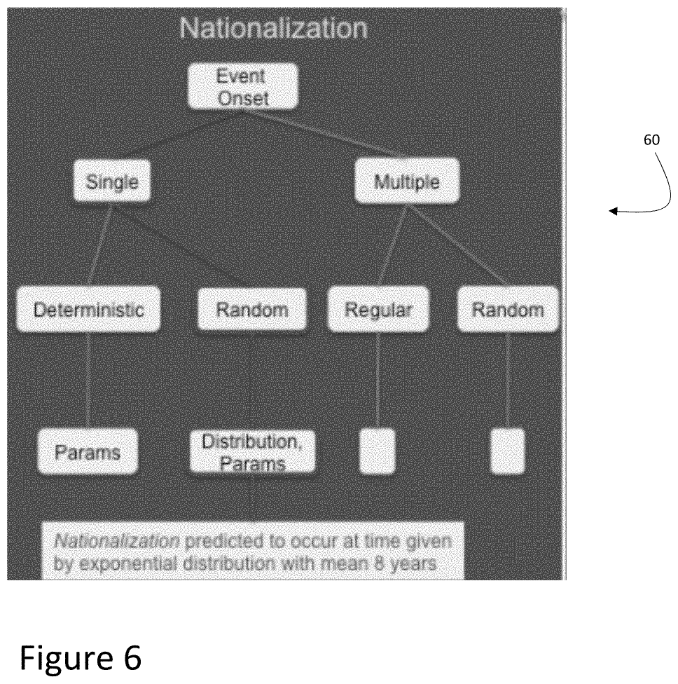

Next, at S3, an assessment of the risk event occurrence, i.e., onset, is constructed. The assessment may be expressed as conditional probabilities involving relationships among risks and risk factors. FIG. 6 depicts a decision tree 60 that shows the steps that the system follows based on previous inputs and be utilizes to collect risk event details. For instance, the user may be queried about whether the risk is more likely to involve a single event or multiple events. If single, the query will ask if the event will be deterministic or random. If random, what parameters will describe the probability distribution of the event, etc.

At S4, the user is queried (or the system evaluates) whether the assessment is satisfactory. In other words, is there enough information or understanding of the risk event to adequately capture the likelihood of an event onset. If the assessment is not deemed satisfactory at S4, then potential risk factors can be identified and assessed at S9. Existing risk factors for a risk event may be stored/retrieved from risk knowledgebase 34 by querying the user. In the examples provided herein, risk factors include, e.g. political unrest, resource nationalism sentiment, resource expropriation acts in neighboring countries, etc.

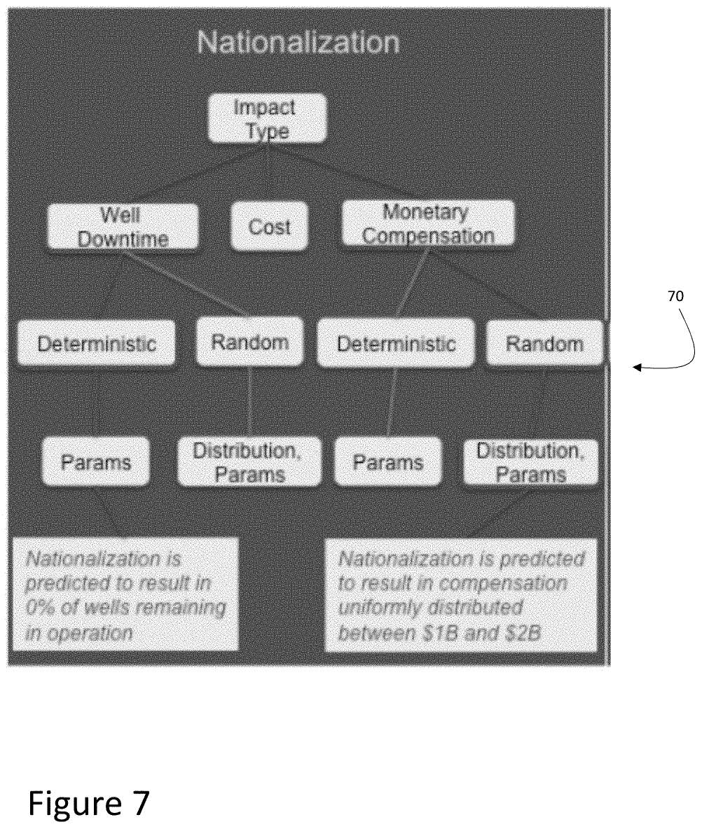

Once the assessment is deemed satisfactory at S4, then potential impacts are identified at S5, including probabilistic characterizations of the severity, duration and impact of a risk event. Impacts for a risk event may likewise be stored/retrieved from risk knowledgebase 34. FIG. 7 depicts a decision tree 70 that may be utilized to guide the process. For example, the user 30 (or risk knowledgebase 34) may specify three type of impacts for “nationalization” including well downtime, cost and monetary compensation. With regard to well downtime, the user 30 may be asked whether the impact is deterministic or random. If deterministic the user 30 may be asked for a set of parameters that describe aspects of a well or multiple wells going off-line.

At S6, a determination is made whether all risk events have been studied, and if not, the process loops back to S2. If yes at S6, then RMB process ends at S7 and the risk model representation 26 is generated and outputted.

The sequence of questions to be asked by the risk model builder GUI can be defined as a graph, where each node is an abstraction of the page that would be presented to a user, containing questions, dropdown menus, dialog boxes into which responses can be input, etc. For flexibility, the graph (and hence the UI) may be defined in JSON. The RMB 24 reads the JSON and interprets it into a UI that elicits the structure and parameters of the risk model representation 26 from the user 30. As an example, below is a JSON snippet that represents just a first node of the graph, which defines a panel that might be presented to a user to elicit which type of risk event the user wants to consider. Note that the children substructure indicates that the user will next be directed to additional nodes that represent other panels that elicit parameters having to do with the onset and duration of the risk event, as well as its impact.

{
“name”: “Risk Event Root”,
“id”: “RiskEventRoot”,
“prompt”: “Select one of the specified types of Risk Events.”,
“children”: [
“onset.RiskEventOnset”,
“impact.RiskEventImpact”,
“duration.RiskEventDuration”
],
“options”: [
“Financial Shock”,
“Trade Dispute”,
“Geopolitical Conflict”,
“Political Violence”,
“Natural Catastrophe”,
“Climate Catastrophe”,
“Environmental Catastrophe”,
“Technological Catastrophe”,
“Disease Outbreak”,
“Humanitarian Crisis”,
“Externality”,
“Other Shock”
],
“multipleChoice”: false
}

Here is an example of the JSON description for eliciting onset information for a risk event node (one of the children of the Risk Event Root JSON above—onset.RiskEventOnset); each node is a point in the decision tree in RiskModelBuilderEventOffset:

```
{
“id”: “onset”, “nodes”: [
    {
    “name”: “Risk Event Onset”, “id”: “RiskEventOnset”,
    “prompt”: “Is the risk event likely to occur just once, or
multiple times?”,
    “children”: [
    “RiskEventOnsetSingle”, “RiskEventOnsetMultiple”
                                ]
                                ,
    “multipleChoice”: false
    },
    {
    “name”: “Single Event Onset”, “id”:
    “RiskEventOnsetSingle”,
    “prompt”: “Is the single risk event expected to happen at a
specific t random?”, dren”: [
  “RiskEventOnsetSingleDeterministic”,
  “RiskEventOnsetSingleRandom”
                                ]
                                ,
                                “multipleChoice”: false
                      },
                      {
                                “name”: “Multiple Event Onset”,
                                “id”: “RiskEventOnsetMultiple”,
                                “prompt”: “Will the multiple
                                risk
  events occur with a regular period, or at random intervals?”,
                                “children”: [
  “RiskEventOnsetMultipleDeterministic”,
  “RiskEventOnsetMultipleRandom”
                                                          },
                                                          {
Deterministic”,
],
“multipleChoice”: false
“name”: “Single Event “id”:
  “RiskEventOnsetSingleDeterministic”,
                                “prompt”: “Enter a probability
                                for
the risk event to occur”,
“Probability”, “number”,
false
“fields”: [
                                                          {
                                                          }
]
“name”:
“type”:
“units”: [ ], “optional”:
                      },
                      {
                                “name”: “Single Event Random”,
                                “id”:
                                “RiskEventOnsetSingleRandom”,
                                “prompt”: “Choose a statistical
  distribution that best captures the time at which the risk event
  would occur, if it does.”,
“uniformDistributionTime”, “triangularDistributionTime”,
“gaussianDistributionTime”
                                                    },
“children”: [
]
                                                          {
Deterministic”,
“name”: “Multiple Event “id”:
  “RiskEventOnsetMultipleDeterministic”,
                                “prompt”: “Enter the period
                                (the
time between events).”,
“Period”,
“number”,
[“month”, “year”, “decade”], false
                                                      },
                                                      {
“fields”: [
                                                          {
                                                          }
]
“name”:
“type”:
“units”: “optional”:
“RiskEventOnsetMultipleRandom”,
“name”: “Multiple Event Random”, “id”:
“prompt”: “Choose a statistical
  distribution that best captures the frequency with which the
  risk event would recur.”,
“uniformDistributionFrequency”,
“children”: [
“triangularDistributionFrequency
”,
“gaussianDistributionFrequency”
                              ]
                      },
                      {
                                “name”: “Uniform
                                Distribution”, “id”:
                                “uniformDistributionTime”,
                                “prompt”: “Enter parameters
                                for the
uniform distribution in occurrence time”,
                                                  “fields”: [
{
“name”:
“Begin”,
“date”, [“date”], false
          “type”:
          “units”: “optional”:
},
{
          “name”: “End”,
“date”, [“date”], false
                                                  “type”:
                                “units”: “optional”:
                              }
          ]
},
{
                                “name”: “Triangular
                                Distribution”, “id”:
                                “triangularDistributionTime”,
                                “prompt”: “Enter parameters
                                for the
triangular distribution in occurrence time”,
                              “fields”:
                                    [
                                          {
“Begin”,
“date”,
[“date”]
“date”,
[“date”]
“Peak”,
“date”,
[“date”]
                                                “name”:
                                                “type”:
                                                “units”:
                              },
                              {
                                “name”: “End”, “type”:
                                                “units”:
                              },
                              {
                                                “name”:
                                                “type”:
                                                “units”:
                              }
          ]
},
{
                                  “name”: “Gaussian
                                  Distribution”, “id”:
                                  “gaussianDistributionTime”,
                                  “prompt”: “Enter parameters
                                  for the
gaussian distribution in occurrence time”,
                                “fields”:
                                    [
                                          {
“Mean”,
“date”,
[“date”]
          “name”:
          “type”:
          “units”:
},
“Standard Deviation”, “date”,
[“date”]
                                                          ]
                      },
                      {
{
          “name”:
          “type”:
          “units”:
}
“uniformDistributionFrequency”,
“name”: “Uniform Distribution”, “id”:
“prompt”: “Enter parameters for the
uniform distribution in occurrence frequency”,
                                                “fields”: [
{
“name”:
“Begin”,
“number”,
month”, “per year”, “per decade”]
“number”,
month”, “per year”, “per decade”]
                                                        ]
                    },
                    {
          “type”: “units”: [“per
},
{
          “name”: “End”, “type”:
          “units”: [“per
}
                                “name”: “Triangular
                                Distribution”, “id”:
“triangularDistributionFrequency”,
                                “prompt”: “Enter parameters
for the triangular distribution in occurrency frequency”,
                              “fields”:
                                    [
                                          {
“Begin”,
“number”,
month”, “per year”, “per decade”]
“number”,
          “name”:
          “type”: “units”: [“per
},
{
          “name”: “End”, “type”:
          “units”: [“per
month”, “per year”, “per decade”]
“Peak”,
“number”,
month”, “per year”, “per decade”], false
                                                          ]
                      },
                      {
},
{
          “name”:
          “type”: “units”: [“per “optional”:
}
“gaussianDistributionFrequency”,
“name”: “Gaussian Distribution”, “id”:
“prompt”: “Enter parameters for the
gaussian distribution in occurrence frequency”,
                                                “fields”: [
                                                        {
“name”:
“Mean”,
“number”,
month”, “per year”, “per decade”]
“Standard Deviation”, “number”,
month”, “per year”, “per decade”]
                                                          ]
                      }
          ]
}
          “type”: “units”: [“per
},
{
          “name”:
          “type”: “units”: [“per
}
```

Here is an example of the JSON describing elicitation of duration information (duration.RiskEventDuration mentioned in Risk Event Root above):

```
{
            “name”: “Duration
            Facet”, “id”:
            “duration”,
            “nodes”: [
                        {
                                    “name”: “Risk Event
                                    Duration”, “id”:
                                    “RiskEventDuration”,
                                    “prompt”: “Is the risk event
likely to last a fixed amount of time, or a random amount of
time?”,
                                    “children”: [
                                                “DurationDeterministic
                                                ”,
                                                “DurationRandom”
                                                            },
                                                            {
duration of the risk event”,
],
“multipleChoice”: false
“name”: “Duration Deterministic”, “id”: “DurationDeterministic”,
“prompt”: “Enter the expected
“fields”: [
                              {
“Duration”, “time”,
[“month”, “year”, “decade”], false
                                                                  ]
                        },
                        {
            “name”:
            “type”:
            “units”: “optional”:
}
                                    “name”: “Duration
                                    Random”, “id”:
                                    “DurationRandom”,
                                    “prompt”: “Choose a statistical
  distribution that best captures the duration of the risk event,
  should it occur.”,
                                    “children”: [
  “uniformDistributionDurationTime”,
  “triangularDistributionDurationTime”,
  “gaussianDistributionDurationTime”
                                  ]
                        },
                        {
                                    “name”: “Uniform
                                    Distribution”, “id”:
  “uniformDistributionDurationTime”,
                                    “prompt”: “Enter parameters for
  the uniform distribution in duration”,
                                  “fields”:
                                        [
                                                {
“Least”,
“time”,
“name”:
“type”:
“units”:
[“month”, “year”, “decade”], false
“Most”,
“time”,
[“month”, “year”, “decade”], false
                                                                  ]
                        },
                        {
            “optional”:
},
{
            “name”:
            “type”:
            “units”: “optional”:
}
                                    “name”: “Triangular
                                    Distribution”, “id”:
“triangularDistributionDurationTime”,
                                    “prompt”: “Enter parameters for
the triangular distribution in duration”,
                                    “fields”
                                        : [
                                                {
“Least”,
“time”,
[“month”, “year”, “decade”]
“Most”,
“time”,
[“month”, “year”, “decade”]
“Peak”,
“time”,
[“month”, “year”, “decade”]
                                                                  ]
                        },
                        {
            “name”:
            “type”:
            “units”:
},
{
            “name”:
            “type”:
            “units”:
},
{
            “name”:
            “type”:
            “units”:
}
                                    “name”: “Gaussian
                                    Distribution”, “id”:
  “gaussianDistributionDurationTime”,
                                    “prompt”: “Enter parameters for
                                    the
gaussian distribution in duration”,
                                                            “fields”: [
                                                                  {
“name”:
“Mean”,
“time”,
[“month”, “year”, “decade”]
“Standard Deviation”, “time”,
[“month”, “year”, “decade”]
                        ]
            }
]
            }
            “type”:
            “units”:
},
{
            “name”:
            “type”:
            “units”:
}
```

Finally, here is an example of the JSON describing elicitation of impact parameters (impact.RiskEventImpact in the Risk Event Root JSON described above):

In the above example, the user interface 22 is rendered automatically from JSON which drives the user 30 through the querying process.

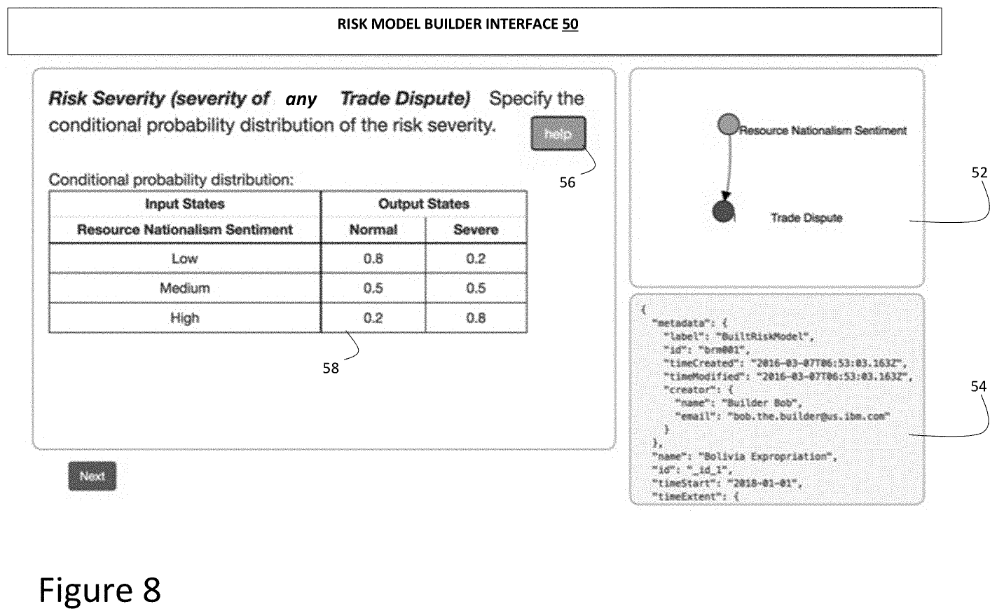

FIG. 8 depicts an illustrative screenshot from an implementation of an RMB interface 50, taken at a stage partway through the querying process. At this point, a single risk factor node (labeled “Resource Nationalism Sentiment”) has been created, and a risk event node has been created for “Trade Dispute”. The conditional probabilities for the risk event node are being entered on this page via table 58. In the upper right-hand corner is a graphical representation of the risk model 52 built thus far, while a JSON representation 54 of the partially-constructed risk model is shown in the lower right-hand corner of the figure. Optionally, in order to assist the user answer questions regarding the structure and parameters of the risk model, a help button 56 may be provided, which if selected by the user may issue relevant queries to a risk store.

Two of the main types of queries that are helpful in this context are:

1. statistics of risk factors most frequently associated with a given region; and

2. documents that are most relevant to a given region and risk type from which a user might be able to infer risk model parameters.

Once the process is complete, the risk model representation 26 may be stored in a database, from whence it can be retrieved by any other element of the risk system 18 that may wish to use it, such as the risk simulation engine 28 (FIG. 1). The risk model representations 26 output by the risk model builder 24 can also be used as the basis for a risk model visualizer tool that would allow the user to (a) see a graphical representation of the model, and (b) display n realizations of risk, to help the user assess whether the model is producing the expected (probabilistic) behavior.

Once the risk model representation 26 is completely specified, it can be analyzed by any of a number of inference techniques. In one embodiment, a risk simulation engine 28 performs such an analysis as follows. First, the risk simulation engine 28 receives a request to generate a requested number of risk impact realizations (i.e., simulations) for a specified risk model 26. Next, the risk simulation engine 28 retrieves the specified risk model representation 26 and uses forward sampling simulation techniques to generate the requested number of realizations that represent a probability distribution of the impacts over a time period of interest.

In a second embodiment, the request is received instead by a risk simulation manager 29, which either retrieves realizations previously computed by the risk simulation engine 28 from a database, or (if none satisfying the request have been pre-computed) risk simulation manager 29 passes the request to the risk simulation engine 28, which performs as described in the first embodiment and returns its results to the risk simulation manager 29, which returns them to the caller and stores them in a database for possible future use.

Upon receiving a request to compute n instances of a specified type of impact (e.g. well downtime wd, cost c, or compensation m) for a given risk model representation r, the risk simulation manager 29 either retrieves these instances from a local database, or arranges for them to be computed by the risk simulation engine 28. If a computation is necessary, risk simulation manager 29 contacts a profile manager to obtain a JSON expression of the risk model representation labeled r and sends the JSON along with a number of instances n to the risk simulation engine 28.

The risk simulation engine 28 generates n instances of whatever subset of wd(t), c(t) and m(t) are specified by the model r. Of note is that the risk model representation 26 itself may contain a specified start and end date that indicates the time span over which the risk model representation 26 is valid. When the risk simulation manager 29 is called, the caller can also specify a date range (which may be contained within the risk model's range of validity). This allows the generated risk simulation to mesh with the needs of the caller.

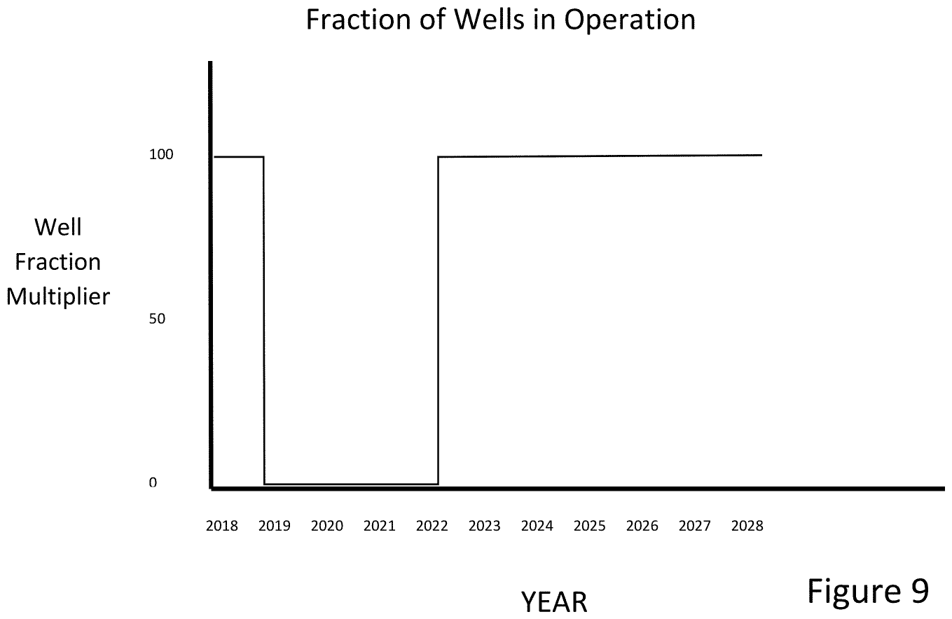

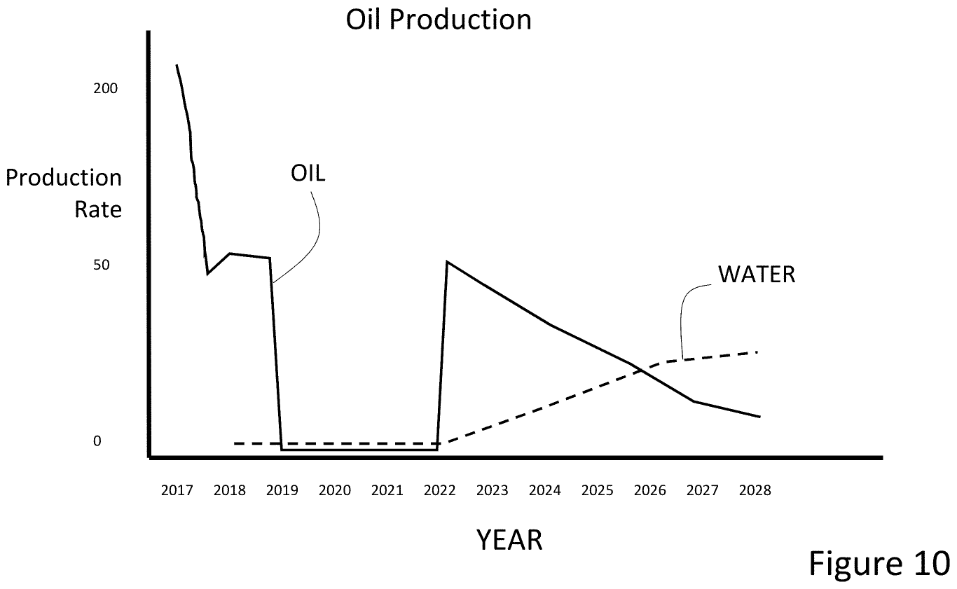

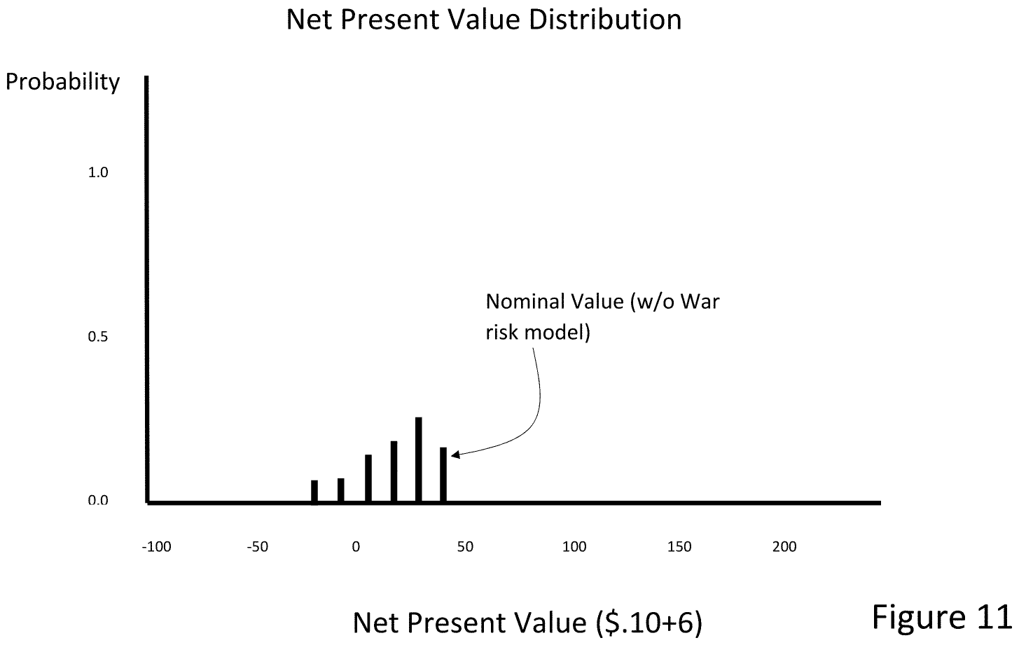

FIG. 9 presents an example simulation run for a civil war risk example that displays a distribution of an impact (well operation) over time. In this particular simulation run, it can be seen that wells in operation will drop to zero from 2019 to 2022. Note that the simulation generated by the risk simulation engine can in turn be input to additional simulators to generate further simulations, from which e.g., financial implications can be calculated. For example, FIG. 10 illustrates the oil output of a reservoir simulator that has been fed a set of constraints that force well operations to be shut down entirely during the period indicated in FIG. 9. As expected, oil production is interrupted during the same period. A financial analysis can then be conducted by generated a set realizations like those depicted in FIG. 9, running each through a reservoir simulator to produce outputs like those depicted in FIG. 10. A net present value of each such realization can be computed for the set of simulations and assembled into a Net Present Value distribution such as that depicted in FIG. 11.

It is understood that risk system 18 (FIG. 1) may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computing system 10 that may comprise any type of computing device and for example includes at least one processor 12, memory 20, an input/output (I/O) 14 (e.g., one or more I/O interfaces and/or devices), and a communications pathway 16. In general, processor(s) 12 execute program code which is at least partially fixed in memory 20. While executing program code, processor(s) 12 can process data, which can result in reading and/or writing transformed data from/to memory and/or I/O 14 for further processing. The pathway 16 provides a communications link between each of the components in computing system 10. I/O 14 can comprise one or more human I/O devices, which enable a user to interact with computing system 10. Computing system 10 may also be implemented in a distributed manner such that different components reside in different physical locations.

Furthermore, it is understood that the risk system 18 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A risk system for analyzing long-term risks, comprising:
a risk knowledgebase that includes risk information associated with at least one domain;
a risk model builder that builds a representation of a risk model based on inputs from a user interface and the risk knowledgebase, wherein the risk model includes risk factor nodes, risk event nodes and impact nodes; and
a risk simulation engine that processes the representation and computes predicted outcomes.

2. The risk system of claim 1, wherein the risk model comprises a hierarchy in which risk factor nodes are parents to the risk event nodes, and the risk event nodes are parents to the impact nodes.

3. The risk system of claim 2, wherein each risk factor node includes a set of states and a conditional probability for each state that influences whether or not an associated risk event node occurs.

4. The risk system of claim 3, wherein each risk event node includes a type, frequency and duration.

5. The risk system of claim 4, wherein each impact node includes a probabilistic characterization of a severity and a duration of a risk event onset.

6. The risk system of claim 5, wherein each impact node includes a discrete or continuous distribution.

7. The risk system of claim 1, wherein the risk simulation engine provides an input into which a set of parameters can be entered for a risk mode representation.

8. A computer program product stored on a computer readable storage medium, which when executed by a computing system, analyzes long-term risks, the program product comprising:
program code that accesses risk information associated with at least one domain from a risk knowledgebase;
program code that builds a representation of a risk model based on inputs from a user interface and the risk knowledgebase, wherein the risk model includes risk factor nodes, risk event nodes and impact nodes; and
program code that processes the representation and computes predicted outcomes.

9. The program product of claim 8, wherein the risk model comprises a hierarchy in which risk factor nodes are parents to the risk event nodes, and the risk event nodes are parents to the impact nodes.

10. The program product of claim 9, wherein each risk factor node includes a set of states and a conditional probability for each state that influences whether or not an associated risk event node occurs.

11. The program product of claim 10, wherein each risk event node includes a type, frequency and duration.

12. The program product of claim 11, wherein each impact node includes a probabilistic characterization of a severity and a duration of a risk event onset.

13. The program product of claim 12, wherein each impact node includes a discrete or continuous distribution.

14. The program product of claim 8, further comprising an input for running a simulation into which a set of parameters can be entered for a risk mode representation.

15. A computerized method for analyzing long-term risks, comprising:
providing risk information associated with at least one domain from a risk knowledgebase;
building a representation of a risk model based on inputs from a user interface and the risk knowledgebase, wherein the risk model includes risk factor nodes, risk event nodes and impact nodes; and
simulating the representation and computing predicted outcomes for a set of parameters.

16. The method of claim 15, wherein the risk model comprises a hierarchy in which risk factor nodes are parents to the risk event nodes, and the risk event nodes are parents to the impact nodes.

17. The method of claim 16, wherein each risk factor node includes a set of states and a conditional probability for each state that influences whether or not an associated risk event node occurs.

18. The method of claim 17, wherein each risk event node includes a type, frequency and duration.

19. The method of claim 18, wherein each impact node includes a probabilistic characterization of a severity and a duration of a risk event onset.

20. The method of claim 19, wherein each impact node includes a discrete or continuous distribution.
